(19) United States
(12) Patent Application Publication
(10) Pub. No.: US 2008/0209760 A1
(43) Pub. Date: Sep. 4, 2008

(54) Drying Apparatus

(75) Inventors: Timothy Alexander French, Wiltshire (GB); Peter Nigel Hutchinson, Wiltshire (GB); Frederic Nicolas, Wiltshire (GB)

Correspondence Address: MORRISON & FOERSTER LLP, 1650 TYSONS BOULEVARD, SUITE 400, MCLEAN, VA, 22102, US

(73) Assignee: DYSON TECHNOLOGY LIMITED, Malmesbury (GB)

(21) Appl. No.: 11/997,309

(22) PCT Filed: Jun. 7, 2006
(86) PCT No.: PCT/GB2006/002084

§ 371 Date: Jan. 29, 2008

(30) Foreign Application Priority Data
Jul. 30, 2005 (GB) 0515754.0

(51) Int. Cl. F26B 21/00

(52) U.S. Cl. 34/585; 34/218; 34/202

(57) ABSTRACT

A drying apparatus has a casing, a cavity formed in the casing for receiving an object, a fan located in the casing and creating an airflow, a motor provided in the casing for driving the fan and ducting for carrying the airflow from the fan to at least one opening arranged to emit the airflow into the cavity, wherein the ducting includes at least one air duct in which at least one vane is located, the vane extending in the direction of airflow and dividing the air duct into a plurality of airflow portions.

### REFERENCE TO RELATED APPLICATIONS

This application is a national stage application under 35 USC 371 of International Application No. PCT/GB2006/002084, filed Jun. 7, 2006, which claims the priority of United Kingdom Application No. 0515754.0, filed Jul. 30, 2005, the contents of which prior applications are incorporated herein by reference.

### FIELD OF THE INVENTION

The invention relates to drying apparatus which makes use of a narrow jet of high velocity, high pressure air to dry an object, including part of the human body. Particularly, but not exclusively, the invention relates to a hand dryer in which the air jet is emitted through a slot-like opening in the casing of the hand dryer.

### BACKGROUND OF THE INVENTION

The use of air jets to dry hands is well known. Examples of hand dryers which emit at least one air jet through a slot-like opening are shown in GB 2249026A, JP 2002-034835A and JP 2002306370A. However, in practice it is very difficult to achieve an evenly distributed airflow of sufficiently high momentum to dry the user's hands efficiently in an acceptably short length of time. Furthermore, the amount of noise emitted by a motor suitable for generating an airflow of sufficiently high momentum adequately to dry the user's hands can be unacceptably high.

### SUMMARY OF THE INVENTION

It is an object of the invention to provide drying apparatus in which an airflow of sufficient momentum efficiently to dry the user's hands is produced and in which the noise emitted by the motor is improved in comparison to prior art devices. It is a further object of the present invention to provide drying apparatus in which the noise emitted by the apparatus is comparatively low.

A first aspect of the invention provides drying apparatus having a casing, a cavity formed in the casing for receiving an object, a fan located in the casing and capable of creating an airflow, a motor provided in the casing for driving the fan and ducting for carrying the airflow from the fan to at least one opening arranged to emit the airflow into the cavity, wherein the ducting comprises at least one air duct in which at least one vane is located, the or each vane extending in the direction of airflow and dividing the air duct into a plurality of airflow portions.

Preferably, the or each vane is positioned in the air duct such that the distance between the said vane and any adjacent wall of the air duct or further vane is no more than a predetermined value. This predetermined value is determined in such a way that it is no greater than the half-wavelength of the noise emitted by the motor. In this way, standing waves are prevented form building up in the air duct but plane waves are allowed to pass along the air duct. This reduces the noise emitted by the machine overall and so enhances the comfort with which the user is able to use the drying apparatus.

The predetermined value is therefore calculated as a function of both the operating speed of the motor and the speed of sound in the airflow passing along the air duct. Motor speeds vary from product to product and the speed of sound in the airflow will depend upon the expected operating temperature of the apparatus. However, an optimum predetermined value can be calculated. The formula to be used is thus:

$$Predetermined Value = \frac{30 \times Speed of sound in air duct}{Operating speed of the motor}$$

If the normal operating temperature of the apparatus is approximately 55° C., this can be simplified to:

$$Predetermined Value = \frac{10800}{Operating speed of the motor}$$

In a preferred embodiment, the operating speed of the motor is substantially 90,000 rpm which puts the predetermined value at 120 mm, although the preferred range of predetermined values is between 100 mm and 150 mm. In the embodiment, the distance between any point on the or each vane and the wall of the air duct or adjacent vane (measured in a direction perpendicular to the airflow) is sufficiently small to prevent standing waves being able to build up. The noise of the hand dryer is thus improved in comparison to the noise which would have been emitted absent the vanes.

It is preferred that more than one vane is arranged in the or each air duct and that the vanes are arranged in rows, more preferably rows which overlap one another. If the breadth of each air duct increases in the direction of the airflow, each successive row of vanes has a higher number of vanes than the previous row.

The provision of the vanes in the air ducts assists in strengthening the structure of the air ducts and their direction helps to maintain the direction of airflow within the ducts, particularly as the duct becomes broader.

### BRIEF DESCRIPTION OF THE DRAWINGS

An embodiment of the invention in the form of a hand dryer will now be described with reference to the accompanying drawings, in which:

FIG. 1 is a side view of drying apparatus according to the invention in the form of a hand dryer;

FIG. 2 is a perspective view of the hand dryer of FIG. 1;

FIG. 3 is a side sectional view of the hand dryer of FIG. 1;

FIG. 4 is a side sectional view, shown on an enlarged scale, of the upper ends of the air ducts forming part of the hand dryer of FIG. 1;

FIG. 5 is a schematic sectional side view, shown on a further enlarged scale, of the slot-like opening located in the front wall of the cavity of the hand dryer of FIG. 1;

FIG. 6 is a schematic sectional side view, shown on the same further enlarged scale, of the slot-like opening located in the rear wall of the cavity of the hand dryer of FIG. 1;

FIG. 7 is an isometric view of the ducting forming part of the hand dryer of FIG. 1 shown in isolation from the other components of the apparatus; and

FIG. 8 is a sectional view of one of the air ducts of FIG. 7 showing the location of a plurality of vanes.

### DETAILED DESCRIPTION OF THE INVENTION

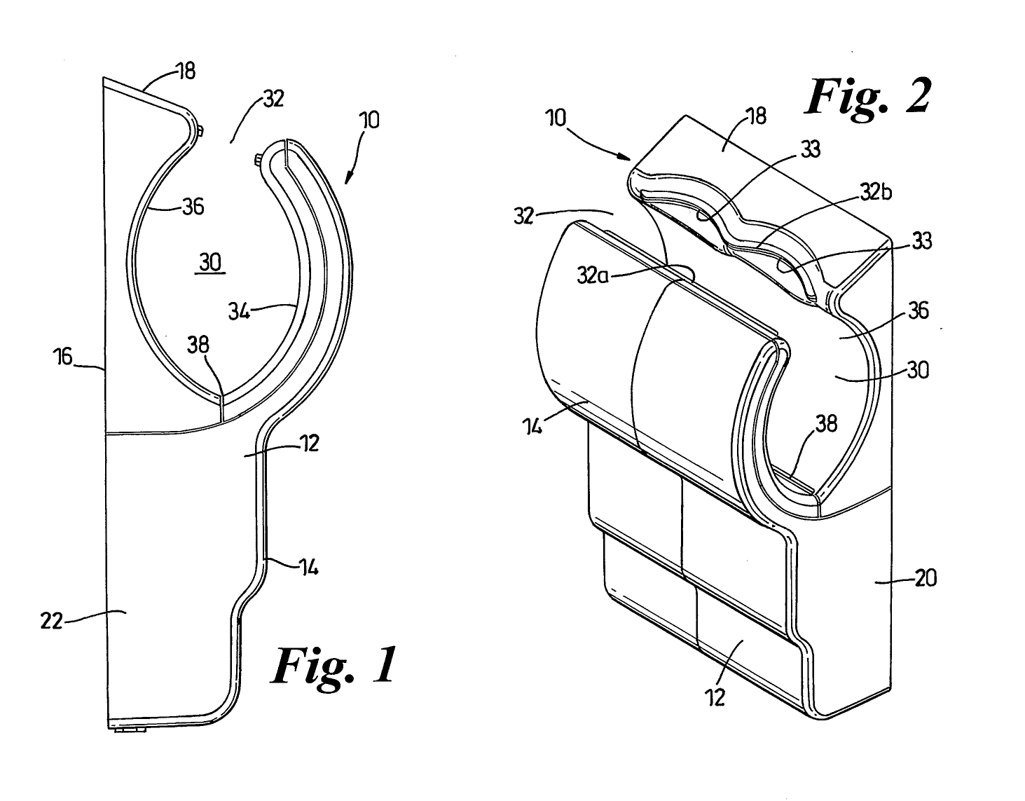

Referring firstly to FIGS. 1 and 2, the hand dryer 10 shown in the drawings comprises an outer casing 12 having a front wall 14, a rear wall 16, an upper face 18 and side walls 20, 22. The rear wall 16 can incorporate fixing devices (not shown) for securing the hand dryer 10 to a wall or other structure prior to use. An electrical connection (not shown) is also provided on the rear wall or elsewhere on the casing 12. A cavity 30 is formed in the upper part of the casing 12 as can be seen from FIGS. 1 and 2. The cavity 30 is open at its upper end and delimited thereat by the top of the front wall 14 and the front of the upper face 18. The space between the top of the front wall 14 and the front of the upper face 18 forms a cavity entrance 32 which is sufficiently wide to allow a user's hands to be introduced to the cavity 30 through the cavity entrance 32. The cavity 30 is also open to the sides of the hand dryer 10 by appropriate shaping of the side walls 20, 22.

The cavity 30 has a front wall 34 and a rear wall 36 which delimit the cavity 30 to the front and rear respectively. Located in the lowermost end of the cavity 30 is a drain 38 which communicates with a reservoir (not shown) located in the lower part of the casing 12. The purpose of the drain and reservoir will be described below.

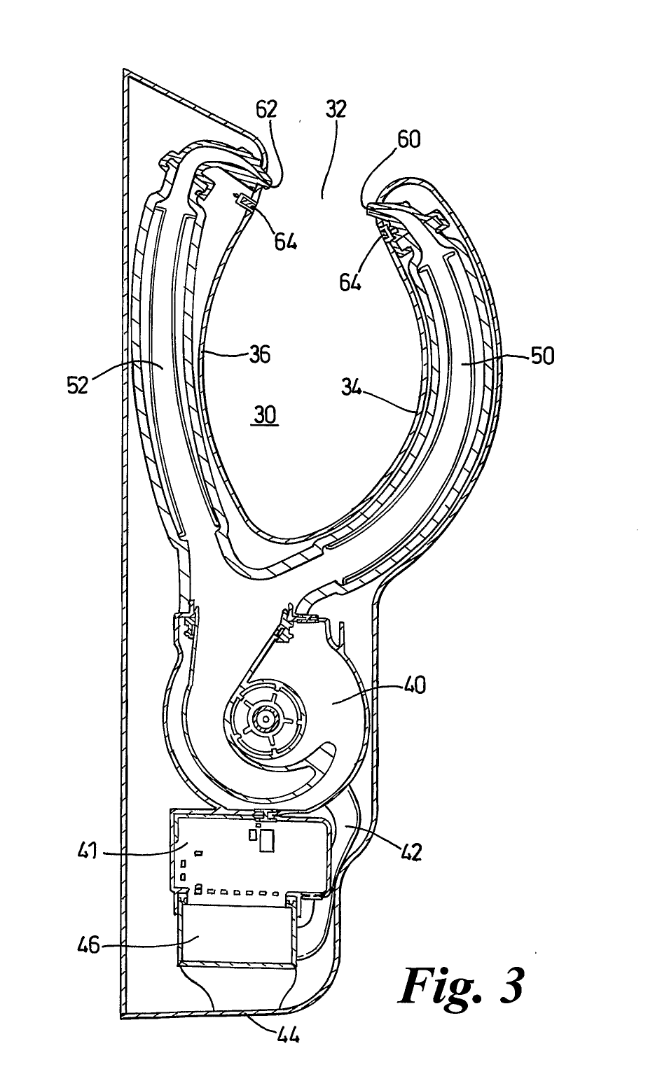

As shown in FIG. 3, a motor (not shown) is located inside the casing 12 and a fan 40, which is driven by the motor, is also located inside the casing 12. The motor is connected to the electrical connection and is controlled by a controller 41. The inlet 42 of the fan 40 communicates with an air inlet 44 formed in the casing 12. A filter 46 is located in the air passageway connecting the air inlet 44 to the fan inlet 42 so as to prevent the ingress of any debris which might cause damage to the motor or the fan 40. The outlet of the fan 40 communicates with a pair of air ducts 50, 52 which are located inside the casing 12. The front air duct 50 is located primarily between the front wall 14 of the casing 12 and the front wall 34 of the cavity 30, and the rear air duct 52 is located primarily between the rear wall 16 of the casing 12 and the rear wall 36 of the cavity 30.

The air ducts 50, 52 are arranged to conduct air from the fan 40 to a pair of opposed slot-like openings 60, 62 which are located in the front and rear walls 34, 36 respectively of the cavity 30. The slot-like openings 60, 62 are arranged at the upper end of the cavity 30 in the vicinity of the cavity entrance 32. The slot-like openings 60, 62 are each configured so as to direct an airflow generally across the cavity entrance 32 towards the opposite wall of the cavity 30. The slot-like openings 60, 62 are offset in the vertical direction and angled towards the lowermost end of the cavity 30.

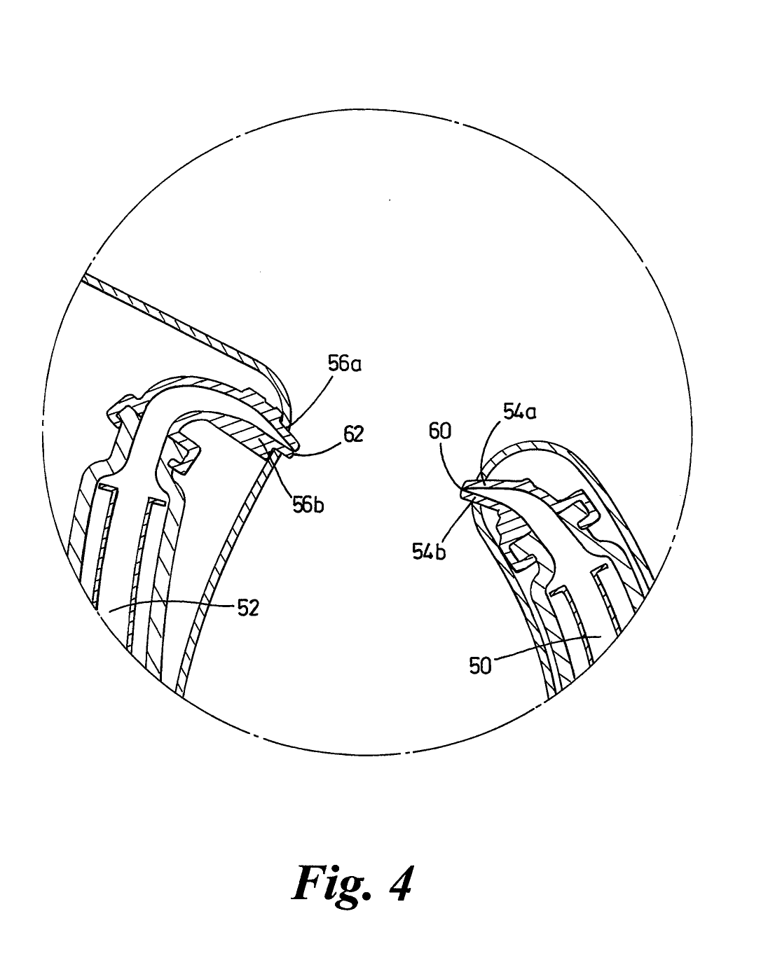

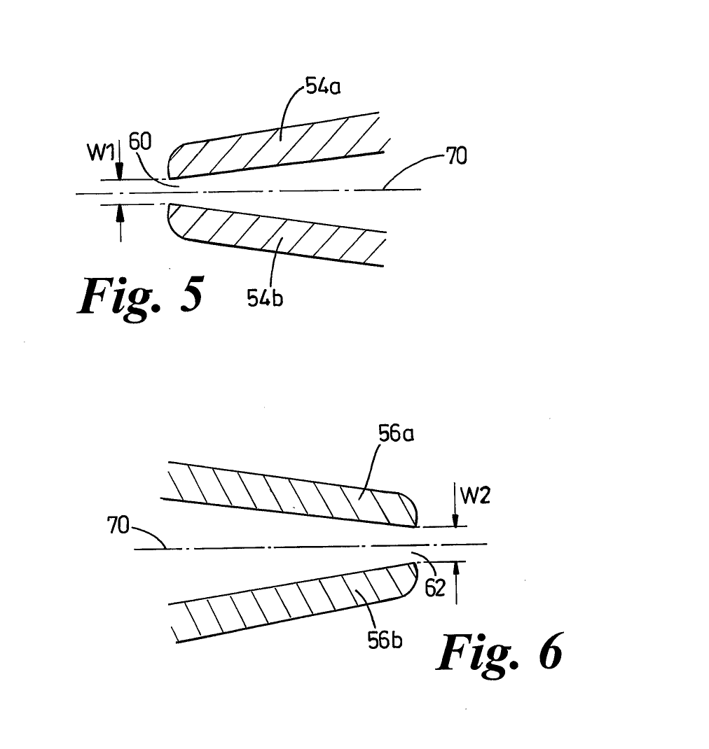

FIG. 4 shows the upper ends of the air ducts 50, 52 and the slot-like openings 60, 62 in greater detail. As can be seen, the walls 54a, 54b of the air duct 50 converge to form the slot-like opening 60 and the walls 56a, 56b of the air duct 52 converge to form the slot-like opening 62. Even greater detail can be seen in FIGS. 5 and 6. FIG. 5 shows that the slot-like opening 60 has a width of W1 and FIG. 6 shows that the slot-like opening 62 has a width of W2. The width W1 of the slot-like opening 60 is smaller than the width W2 of the slot-like opening 62. The width W1 is 0.3 mm and the width W2 is 0.4 mm.

Each pair of walls 54a, 54b, 56a, 56b is arranged so that the respective walls approach one another as they approach the respective slot-like opening 60, 62. If an imaginary axis 70 is considered to lie midway between each pair of walls, as is shown in FIGS. 5 and 6, then each wall 54a, 54b, 56a, 56b lies at an angle of substantially 7° to the respective axis 70. Thus the angle formed between each pair of walls 54a, 54b, 56a, 56b is thus substantially 14°. This angle has been found to be advantageous, although it could be varied by several degrees. Angles of between 100 and 200 may be used.

Sensors 64 are positioned in the front and rear walls 34, 36 of the cavity 30 immediately below the slot-like openings 60, 62. These sensors 64 detect the presence of a user's hands which are inserted into the cavity 30 via the cavity entrance 32 and are arranged to send a signal to the motor when a user's hands are introduced to the cavity 30. As can be seen from FIGS. 1 and 3, the walls 54a, 54b, 56a, 56b of the ducts 50, 52 project slightly beyond the surface of the front and rear walls 34, 36 of the cavity 30. The inward projection of the walls 54a, 54b, 56a, 56b of the ducts 50, 52 reduces the tendency of the user's hands to be sucked towards one or other of the walls 34, 36 of the cavity, which enhances the ease with which the hand dryer 10 can be used. The positioning of the sensors 64 immediately below the inwardly projecting walls 54a, 54b, 56a, 56b of the ducts 50, 52 also reduces the risk of the sensors 64 becoming dirty and inoperative.

As can be seen from FIG. 2, the shape of the cavity entrance 32 is such that the front edge 32a is generally straight and extends laterally across the width of the hand dryer 10. However, the rear edge 32b has a shape which consists of two curved portions 33 which generally follow the shape of the backs of a pair of human hands as they are inserted downwardly into the cavity 30 through the cavity entrance 32. The rear edge 32b of the cavity entrance 32 is substantially symmetrical about the centre line of the hand dryer 10. The intention of the shaping and dimensioning of the front and rear edges 32a, 32b of the cavity entrance 32 is that, when a user's hands are inserted into the cavity 30 through the cavity entrance 32, the distance from any point on the user's hands to the nearest slot-like opening is substantially uniform.

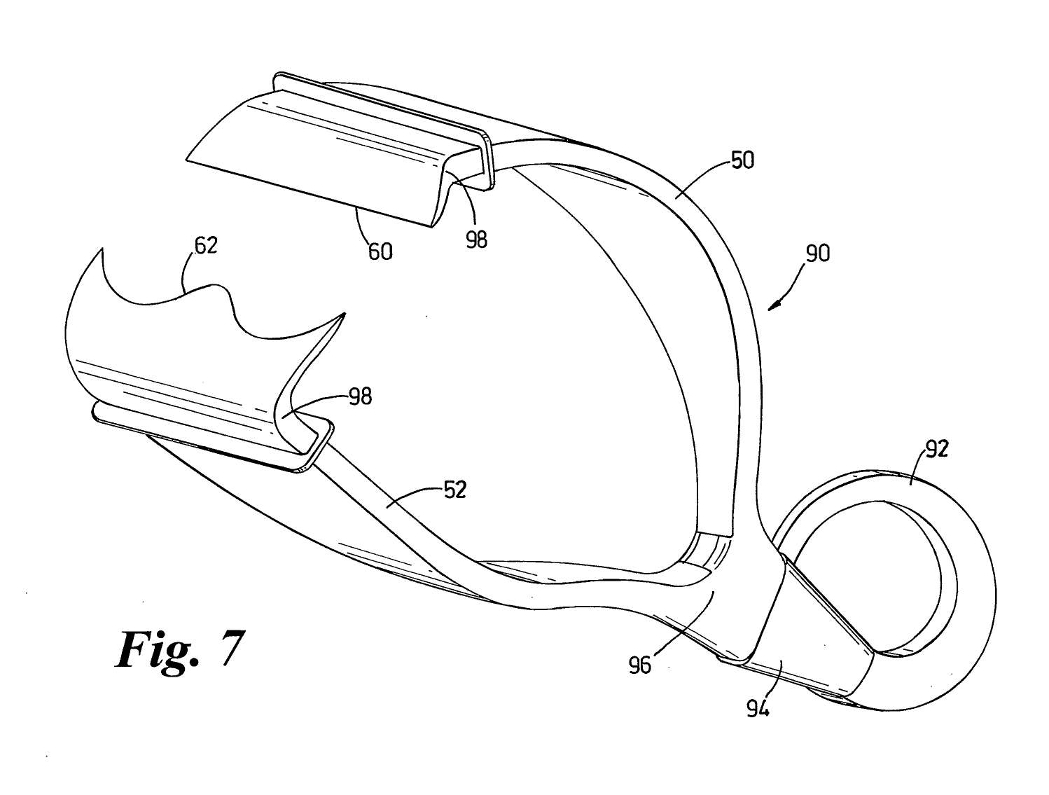

The air ducts 50, 52 form part of the ducting 90 which lies between the fan 40 and the slot-like openings 60, 62. A perspective view of the ducting 90 is shown in FIG. 7. The ducting 90 includes a scroll 92 which lies adjacent the fan 40 and receives the airflow generated by the fan 40. The scroll 92 communicates with a first chamber 94 which is generally square in cross-section, although the cross-section could easily be generally circular. The intention is that the cross-section of the chamber 94 should have dimensions which are substantially the same in both directions. Immediately downstream of the chamber 94 is a Y-junction 96 downstream of which the air ducts 50, 52 are located. As has been described above, the air ducts 50, 52 pass towards the upper end of the casing 12 with the front air duct 50 being located between the front wall 14 of the casing 12 and the front wall 34 of the cavity 30 and the rear duct 52 being located between the rear wall 16 of the casing 12 and the rear wall 36 of the cavity 30. The air ducts 50, 52 communicate with the slot-like openings 60, 62 at the upper end of the cavity 30.

The ducting 90 is designed so that the cross-sectional area of the ducting 90 gradually transforms from the generally square (or circular) shape of the chamber 94 to the slot-like shape of the openings in a smooth and gradual manner. Immediately downstream of the chamber 94, the ducting divides into the air ducts 50, 52, at the upstream end of which the cross-sectional area is still generally square in shape—ie, the breadth and depth of the cross-section are substantially similar. However, the cross-section changes gradually with distance from the chamber 94 so that the breadth of each duct 50, 52 increases as the depth reduces. All of the changes are smooth and gradual to minimise any frictional losses.

At a point 98 immediately upstream of each of the slot-like openings 60, 62, the cross-sectional area of each of the air ducts 60, 62 begins to decrease so as to cause the velocity of the airflow travelling towards the slot-like openings 60, 62 to increase dramatically. However, between the chamber 94 and the point 98 in each air duct 50, 52, the total cross-sectional area of the ducting (ie. the combined cross-sectional area of the air ducts 50 and 52) remains substantially constant.

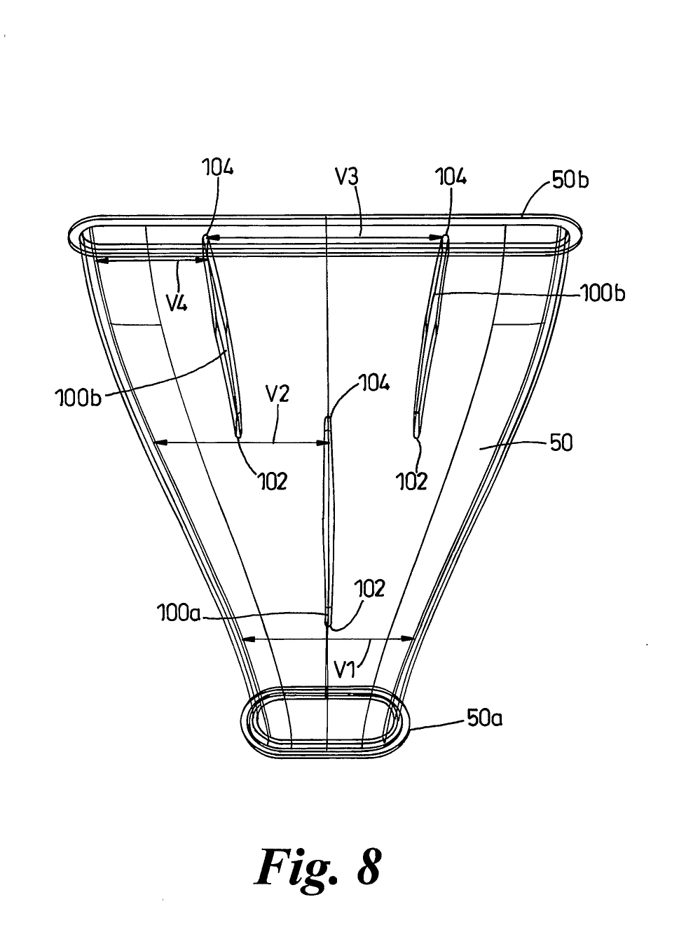

FIG. 8 shows the air duct 50 in section, the section being taken along the centre-line of the duct 50 itself. As can be seen, the lower end 50a of the duct 50 has a generally elongate cross-section and is adapted to communicate with one of the branches of the Y-junction 96. The upper end 50b of the air duct 50 communicates with the point 98 which is immediately upstream of the slot-like opening 60. The air duct 50 broadens as it approaches the upper end 50b.

Inside the air duct 50, three vanes 100 are provided. The vanes 100 have an elongate shape and lie so as to extend in the direction of the airflow passing along the air duct 50. To this end, the single upstream vane 100a is positioned so as to lie along the central axis of the duct 50 but the downstream vanes 100b are inclined slightly towards the side walls of the duct 50 so as to follow the steamlines of the airflow passing along the duct 50. Each vane 100 has an upstream edge 102 and a downstream edge 104, and each edge 102, 104 is radiussed so as to minimise any turbulence created in the airflow by virtue of their presence.

The position of the vanes 100a, 100b within the duct 50 is determined so that the distance between any one vane 100a, 100b and either the wall of the air duct 50 or an adjacent vane 100b is no more than half of the wavelength of the noise emitted by the motor. This is determined according to the operating speed of the motor and the velocity of sound within the airflow travelling along the air duct 50. It will be appreciated that this distance can be calculated according to the formula:

$$Predetermined Value = \frac{30 \times Speed of sound in air duct}{Operating speed of the motor}$$

It will also be appreciated that the speed of sound in the airflow will vary according to the temperature and pressure of the airflow. To simplify the calculation, it has been found effective to use in this equation the speed of sound in the airflow at the slot-like openings, which is the point at which the temperature is likely to be lowest. Under normal operating conditions of the hand dryer shown in the embodiment, we expect the airflow temperature at the slot-like openings to be approximately 55° C.—at which temperature the speed of sound in air is approximately 360 m/s. The predetermined value can them be calculated using the simplified formula:

$$Predetermined Value = \frac{10800}{Operating speed of the motor}$$

In the embodiment, the motor is designed to operate at a speed of approximately 90,000 rpm. The predetermined value is then calculated to be 120 mm. Other speeds of the motor result in the predetermined value being selected to be between 100 mm and 150 mm.

Having calculated the predetermined value, the vanes 100a, 100b are positioned in the air duct 50 so that all relevant distances are no more than this value—and can be considerably less. The distances V1-V4 which are to be no greater than the predetermined value are shown in FIG. 8.

As the breadth of the air duct 50 increases, the need to provide larger numbers of vanes also increases. The vanes 100 are thus arranged in rows with a single vane 100a provided in the first, upstream row and two vanes 100b provided in the next row. If the breadth of the air duct 50 had been sufficiently large in the downstream area, or if the predetermined value had been smaller so that only two vanes 100b were insufficient, three vanes 100b could easily have been provided.

The rows of vanes 100 are located so that the upstream edges 102 of the vanes 100b overlap with the downstream edge 104 of the vane 100a. This ensures that no point of the air duct 50 is left unrestricted in terms of the distance between the vanes 100 and the walls of the duct 50.

It will be appreciated that vanes 100 are provided in the air duct 52 in the same manner as those provided in the air duct 50, with the predetermined value being calculated in the same way.

The hand dryer 10 described above operates in the following manner. When a user's hands are first inserted into the cavity 30 through the cavity entrance 32, the sensors 64 detect the presence of the user's hands and send a signal to the motor to drive the fan 40. The fan 40 is thus activated and air is drawn into the hand dryer 10 via the air inlet 44 at a rate of approximately 20 to 40 litres per second and preferably at a rate of least 25 to 27 litres per second, more preferably air is drawn into the hand dryer 10 at a rate of 31 to 35 litres per second. The air passes through the filter 46 and along the fan inlet 42 to the fan 40. The airflow leaving the fan 40 is divided into two separate airflows; one passing along the front air duct 50 to the slot-like opening 60 and the other passing along the rear air duct 52 to the slot-like opening 62.

As the airflow passes along the air ducts 50, 52, it divides into a plurality of airflow portions and flows past the vanes 100 located in each air duct 50, 52. The noise emitted by the motor is attenuated by the fact that the distance between the vanes 100 and the walls of the ducts 50, 52, and between the vanes 100 themselves, is restricted to a value which does not exceed the half-wavelength of the sound waves of the noise.

The airflow is ejected from the slot-like openings 60, 62 in the form of very thin, stratified sheets of high velocity, high pressure air. As the airflows leave the slot-like openings 60, 62, the air pressure is at least 15 kPa and preferably approximately 20 to 23 kPa. Furthermore, the speed of the airflow leaving the slot-like openings 60, 62 is at least 80 m/s and preferably at least 100 or 150 m/s, more preferably approximately 180 m/s. Because the size of the slot-like opening 62 located at the end of the rear duct 52 is greater than the size of the slot-like opening 60 located at the end of the front duct 50, a larger volume of air is emitted from the duct 52 than from the duct 50. This provides a greater mass of air for drying the backs of the user's hands which is advantageous.

The two thin sheets of stratified, high velocity, high pressure air are directed towards the surfaces of the user's hands which, during use, are inserted fully into the cavity 30 and are subsequently withdrawn from the cavity 30 via the cavity entrance 32. As the user's hands pass into and out of the cavity 30, the sheets of air blow any existing water off the user's hands. This is achieved reliably and effectively because of the high momentum of the air leaving the slot-like openings 60, 62 and because the airflow is evenly distributed along the length of each slot-like opening 60, 62.

Each stratified sheet of air is directed towards the wall of the cavity 30 which is remote from the slot-like opening through which the respective sheet of air is emitted. Because the slot-like openings 60, 62 are also inclined towards the lowermost end of the cavity 30, the emitted airflows are directed into the cavity 30. This reduces the risk of turbulent air movement being felt by the user outside the casing, e.g. in the user's face.

It is envisaged that it will take only a small number of “passes” of the hand dryer described above to dry a user's hands to a satisfactory degree. (By “pass”, we mean a single insertion of the hands into the cavity and subsequent removal therefrom at a speed which is not unacceptable to an average user. We envisage that a single pass will have a duration of no more than 3 seconds.) The momentum achieved by the airflows is sufficient to remove the majority of water found on the surface of the user's hands after washing during a single pass.

The water removed by the airflows is collected inside the cavity 30. Each airflow will rapidly lose its momentum once it has passed the user's hands and the water droplets will fall to the lower end of the cavity 30 under the forces of gravity whilst the air exits the cavity 30 either through the cavity entrance 32 or via the open sides of the cavity 30. The water, however, is collected by the drain 38 and passed to a reservoir (not shown) where it is collected for disposal. The reservoir can be emptied manually if desired. Alternatively, the hand dryer 10 can incorporate some form of water dispersal system including, for example, a heater for evaporating the collected water into the atmosphere. The means by which the collected water is dispersed does not form part of the present invention.

In an alternative embodiment, the slot-like openings 60a, 62a can be arranged so that the sheets of air which are emitted therefrom are directed generally along planes which are substantially parallel to one another. This minimises the amount of turbulent flow present inside the cavity 30 whilst the drying apparatus is in use.

The invention is not intended to be limited to the precise detail of the embodiment described above. Modifications and variations to the detail which do not alter the scope of the invention will be apparent to a skilled reader. For example, the shape of the cavity 30 and its entrance 32 may be altered without departing from the essence of the present invention. Also, the operational speed of the motor is not limited to the value given above but can be selected to provide the most suitable flowrate of air within the dryer.

### Drying Apparatus

The invention relates to drying apparatus which makes use of a narrow jet of high velocity, high pressure air to dry an object, including part of the human body. Particularly, but not exclusively, the invention relates to a hand dryer in which the air jet is emitted through a slot-like opening in the casing of the hand dryer.

The use of air jets to dry hands is well known. Examples of hand dryers which emit at least one air jet through a slot-like opening are shown in GB 2249026A, JP 2002-034835A and JP 2002306370A. However, in practice it is very difficult to achieve an evenly distributed airflow of sufficiently high momentum to dry the user's hands efficiently in an acceptably short length of time. Furthermore, the amount of noise emitted by a motor suitable for generating an airflow of sufficiently high momentum adequately to dry the user's hands can be unacceptably high.

It is an object of the invention to provide drying apparatus in which an airflow of sufficient momentum efficiently to dry the user's hands is produced and in which the noise emitted by the motor is improved in comparison to prior art devices. It is a further object of the present invention to provide drying apparatus in which the noise emitted by the apparatus is comparatively low.

A first aspect of the invention provides drying apparatus having a casing, a cavity formed in the casing for receiving an object, a fan located in the casing and capable of creating an airflow, a motor provided in the casing for driving the fan and ducting for carrying the airflow from the fan to at least one opening arranged to emit the airflow into the cavity, wherein the ducting comprises at least one air duct in which at least one vane is located, the or each vane extending in the direction of airflow and dividing the air duct into a plurality of airflow portions.

Preferably, the or each vane is positioned in the air duct such that the distance between the said vane and any adjacent wall of the air duct or further vane is no more than a predetermined value. This predetermined value is determined in such a way that it is no greater than the half-wavelength of the noise emitted by the motor. In this way, standing waves are prevented form building up in the air duct but plane waves are allowed to pass along the air duct. This reduces the noise emitted by the machine overall and so enhances the comfort with which the user is able to use the drying apparatus.

The predetermined value is therefore calculated as a function of both the operating speed of the motor and the speed of sound in the airflow passing along the air duct. Motor speeds vary from product to product and the speed of sound in the airflow will depend upon the expected operating temperature of the apparatus. However, an optimum predetermined value can be calculated. The formula to be used is thus:

$$Predetermined Value = \frac{30 \times Speed of sound in air duct}{Operating speed of the motor}$$

If the normal operating temperature of the apparatus is approximately 55° C., this can be simplified to:

$$Predetermined Value = \frac{10800}{Operating speed of the motor}$$

In a preferred embodiment, the operating speed of the motor is substantially 90,000 rpm which puts the predetermined value at 120 mm, although the preferred range of predetermined values is between 100 mm and 150 mm. In the embodiment, the distance between any point on the or each vane and the wall of the air duct or adjacent vane (measured in a direction perpendicular to the airflow) is sufficiently small to prevent standing waves being able to build up. The noise of the hand dryer is thus improved in comparison to the noise which would have been emitted absent the vanes.

It is preferred that more than one vane is arranged in the or each air duct and that the vanes are arranged in rows, more preferably rows which overlap one another. If the breadth of each air duct increases in the direction of the airflow, each successive row of vanes has a higher number of vanes than the previous row.

The provision of the vanes in the air ducts assists in strengthening the structure of the air ducts and their direction helps to maintain the direction of airflow within the ducts, particularly as the duct becomes broader.

An embodiment of the invention in the form of a hand dryer will now be described with reference to the accompanying drawings, in which:

FIG. 1 is a side view of drying apparatus according to the invention in the form of a hand dryer;

FIG. 2 is a perspective view of the hand dryer of FIG. 1;

FIG. 3 is a side sectional view of the hand dryer of FIG. 1;

FIG. 4 is a side sectional view, shown on an enlarged scale, of the upper ends of the air ducts forming part of the hand dryer of FIG. 1;

FIG. 5 is a schematic sectional side view, shown on a further enlarged scale, of the slot-like opening located in the front wall of the cavity of the hand dryer of FIG. 1;

FIG. 6 is a schematic sectional side view, shown on the same further enlarged scale, of the slot-like opening located in the rear wall of the cavity of the hand dryer of FIG. 1;

FIG. 7 is an isometric view of the ducting forming part of the hand dryer of FIG. 1 shown in isolation from the other components of the apparatus; and

FIG. 8 is a sectional view of one of the air ducts of FIG. 7 showing the location of a plurality of vanes.

Referring firstly to FIGS. 1 and 2, the hand dryer 10 shown in the drawings comprises an outer casing 12 having a front wall 14, a rear wall 16, an upper face 18 and side walls 20, 22. The rear wall 16 can incorporate fixing devices (not shown) for securing the hand dryer 10 to a wall or other structure prior to use. An electrical connection (not shown) is also provided on the rear wall or elsewhere on the casing 12. A cavity 30 is formed in the upper part of the casing 12 as can be seen from FIGS. 1 and 2. The cavity 30 is open at its upper end and delimited thereat by the top of the front wall 14 and the front of the upper face 18. The space between the top of the front wall 14 and the front of the upper face 18 forms a cavity entrance 32 which is sufficiently wide to allow a user's hands to be introduced to the cavity 30 through the cavity entrance 32. The cavity 30 is also open to the sides of the hand dryer 10 by appropriate shaping of the side walls 20, 22.

The cavity 30 has a front wall 34 and a rear wall 36 which delimit the cavity 30 to the front and rear respectively. Located in the lowermost end of the cavity 30 is a drain 38 which communicates with a reservoir (not shown) located in the lower part of the casing 12. The purpose of the drain and reservoir will be described below.

As shown in FIG. 3, a motor (not shown) is located inside the casing 12 and a fan 40, which is driven by the motor, is also located inside the casing 12. The motor is connected to the electrical connection and is controlled by a controller 41. The inlet 42 of the fan 40 communicates with an air inlet 44 formed in the casing 12. A filter 46 is located in the air passageway connecting the air inlet 44 to the fan inlet 42 so as to prevent the ingress of any debris which might cause damage to the motor or the fan 40. The outlet of the fan 40 communicates with a pair of air ducts 50, 52 which are located inside the casing 12. The front air duct 50 is located primarily between the front wall 14 of the casing 12 and the front wall 34 of the cavity 30, and the rear air duct 52 is located primarily between the rear wall 16 of the casing 12 and the rear wall 36 of the cavity 30. The air ducts 50, 52 are arranged to conduct air from the fan 40 to a pair of opposed slot-like openings 60, 62 which are located in the front and rear walls 34, 36 respectively of the cavity 30. The slot-like openings 60, 62 are arranged at the upper end of the cavity 30 in the vicinity of the cavity entrance 32. The slot-like openings 60, 62 are each configured so as to direct an airflow generally across the cavity entrance 32 towards the opposite wall of the cavity 30. The slot-like openings 60, 62 are offset in the vertical direction and angled towards the lowermost end of the cavity 30.

FIG. 4 shows the upper ends of the air ducts 50, 52 and the slot-like openings 60, 62 in greater detail. As can be seen, the walls 54a, 54b of the air duct 50 converge to form the slot-like opening 60 and the walls 56a, 56b of the air duct 52 converge to form the slot-like opening 62. Even greater detail can be seen in FIGS. 5 and 6. FIG. 5 shows that the slot-like opening 60 has a width of W and FIG. 6 shows that the slot-like opening 62 has a width of W2. The width W1 of the slot-like opening 60 is smaller than the width W2 of the slot-like opening 62. The width W1 is 0.3 mm and the width W2 is 0.4 mm.

Each pair of walls 54a, 54b, 56a, 56b is arranged so that the respective walls approach one another as they approach the respective slot-like opening 60, 62. If an imaginary axis 70 is considered to lie midway between each pair of walls, as is shown in FIGS. 5 and 6, then each wall 54a, 54b, 56a, 56b lies at an angle of substantially 7° to the respective axis 70. Thus the angle formed between each pair of walls 54a, 54b, 56a, 56b is thus substantially 14°. This angle has been found to be advantageous, although it could be varied by several degrees. Angles of between 10° and 20° may be used.

Sensors 64 are positioned in the front and rear walls 34, 36 of the cavity 30 immediately below the slot-like openings 60, 62. These sensors 64 detect the presence of a user's hands which are inserted into the cavity 30 via the cavity entrance 32 and are arranged to send a signal to the motor when a user's hands are introduced to the cavity 30. As can be seen from FIGS. 1 and 3, the walls 54a, 54b, 56a, 56b of the ducts 50, 52 project slightly beyond the surface of the front and rear walls 34, 36 of the cavity 30. The inward projection of the walls 54a, 54b, 56a, 56b of the ducts 50, 52 reduces the tendency of the user's hands to be sucked towards one or other of the walls 34, 36 of the cavity, which enhances the ease with which the hand dryer 10 can be used. The positioning of the sensors 64 immediately below the inwardly projecting walls 54a, 54b, 56a, 56b of the ducts 50, 52 also reduces the risk of the sensors 64 becoming dirty and inoperative.

As can be seen from FIG. 2, the shape of the cavity entrance 32 is such that the front edge 32a is generally straight and extends laterally across the width of the hand dryer 10. However, the rear edge 32b has a shape which consists of two curved portions 33 which generally follow the shape of the backs of a pair of human hands as they are inserted downwardly into the cavity 30 through the cavity entrance 32. The rear edge 32b of the cavity entrance 32 is substantially symmetrical about the centre line of the hand dryer 10. The intention of the shaping and dimensioning of the front and rear edges 32a, 32b of the cavity entrance 32 is that, when a user's hands are inserted into the cavity 30 through the cavity entrance 32, the distance from any point on the user's hands to the nearest slot-like opening is substantially uniform.

The air ducts 50, 52 form part of the ducting 90 which lies between the fan 40 and the slot-like openings 60, 62. A perspective view of the ducting 90 is shown in FIG. 7. The ducting 90 includes a scroll 92 which lies adjacent the fan 40 and receives the airflow generated by the fan 40. The scroll 92 communicates with a first chamber 94 which is generally square in cross-section, although the cross-section could easily be generally circular. The intention is that the cross-section of the chamber 94 should have dimensions which are substantially the same in both directions. Immediately downstream of the chamber 94 is a Y-junction 96 downstream of which the air ducts 50, 52 are located. As has been described above, the air ducts 50, 52 pass towards the upper end of the casing 12 with the front air duct 50 being located between the front wall 14 of the casing 12 and the front wall 34 of the cavity 30 and the rear duct 52 being located between the rear wall 16 of the casing 12 and the rear wall 36 of the cavity 30. The air ducts 50, 52 communicate with the slot-like openings 60, 62 at the upper end of the cavity 30.

The ducting 90 is designed so that the cross-sectional area of the ducting 90 gradually transforms from the generally square (or circular) shape of the chamber 94 to the slot-like shape of the openings in a smooth and gradual manner. Immediately downstream of the chamber 94, the ducting divides into the air ducts 50, 52, at the upstream end of which the cross-sectional area is still generally square in shape—ie, the breadth and depth of the cross-section are substantially similar. However, the cross-section changes gradually with distance from the chamber 94 so that the breadth of each duct 50, 52 increases as the depth reduces. All of the changes are smooth and gradual to minimise any frictional losses.

At a point 98 immediately upstream of each of the slot-like openings 60, 62, the cross-sectional area of each of the air ducts 60, 62 begins to decrease so as to cause the velocity of the airflow travelling towards the slot-like openings 60, 62 to increase dramatically. However, between the chamber 94 and the point 98 in each air duct 50, 52, the total cross-sectional area of the ducting (ie. the combined cross-sectional area of the air ducts 50 and 52) remains substantially constant.

FIG. 8 shows the air duct 50 in section, the section being taken along the centre-line of the duct 50 itself. As can be seen, the lower end 50a of the duct 50 has a generally elongate cross-section and is adapted to communicate with one of the branches of the Y-junction 96. The upper end 50b of the air duct 50 communicates with the point 98 which is immediately upstream of the slot-like opening 60. The air duct 50 broadens as it approaches the upper end 50b.

Inside the air duct 50, three vanes 100 are provided. The vanes 100 have an elongate shape and lie so as to extend in the direction of the airflow passing along the air duct 50. To this end, the single upstream vane 100a is positioned so as to lie along the central axis of the duct 50 but the downstream vanes 100b are inclined slightly towards the side walls of the duct 50 so as to follow the steamlines of the airflow passing along the duct 50. Each vane 100 has an upstream edge 102 and a downstream edge 104, and each edge 102, 104 is radiussed so as to minimise any turbulence created in the airflow by virtue of their presence.

The position of the vanes 100a, 100b within the duct 50 is determined so that the distance between any one vane 100a, 100b and either the wall of the air duct 50 or an adjacent vane 100b is no more than half of the wavelength of the noise emitted by the motor. This is determined according to the operating speed of the motor and the velocity of sound within the airflow travelling along the air duct 50. It will be appreciated that this distance can be calculated according to the formula:

$$Predetermined Value = \frac{30 \times Speed of sound in air duct}{Operating speed of the motor}$$

It will also be appreciated that the speed of sound in the airflow will vary according to the temperature and pressure of the airflow. To simplify the calculation, it has been found effective to use in this equation the speed of sound in the airflow at the slot-like openings, which is the point at which the temperature is likely to be lowest. Under normal operating conditions of the hand dryer shown in the embodiment, we expect the airflow temperature at the slot-like openings to be approximately 55° C.—at which temperature the speed of sound in air is approximately 360 m/s. The predetermined value can them be calculated using the simplified formula:

$$Predetermined Value = \frac{10800}{Operating speed of the motor}$$

In the embodiment, the motor is designed to operate at a speed of approximately 90,000 rpm. The predetermined value is then calculated to be 120 mm. Other speeds of the motor result in the predetermined value being selected to be between 100 mm and 150 mm.

Having calculated the predetermined value, the vanes 100a, 100b are positioned in the air duct 50 so that all relevant distances are no more than this value—and can be considerably less. The distances V1-V4 which are to be no greater than the predetermined value are shown in FIG. 8.

As the breadth of the air duct 50 increases, the need to provide larger numbers of vanes also increases. The vanes 100 are thus arranged in rows with a single vane 100a provided in the first, upstream row and two vanes 100b provided in the next row. If the breadth of the air duct 50 had been sufficiently large in the downstream area, or if the predetermined value had been smaller so that only two vanes 100b were insufficient, three vanes 100b could easily have been provided.

The rows of vanes 100 are located so that the upstream edges 102 of the vanes 100b overlap with the downstream edge 104 of the vane 100a. This ensures that no point of the air duct 50 is left unrestricted in terms of the distance between the vanes 100 and the walls of the duct 50.

It will be appreciated that vanes 100 are provided in the air duct 52 in the same manner as those provided in the air duct 50, with the predetermined value being calculated in the same way.

The hand dryer 10 described above operates in the following manner. When a user's hands are first inserted into the cavity 30 through the cavity entrance 32, the sensors 64 detect the presence of the user's hands and send a signal to the motor to drive the fan 40. The fan 40 is thus activated and air is drawn into the hand dryer 10 via the air inlet 44 at a rate of approximately 20 to 40 litres per second and preferably at a rate of least 25 to 27 litres per second, more preferably air is drawn into the hand dryer 10 at a rate of 31 to 35 litres per second. The air passes through the filter 46 and along the fan inlet 42 to the fan 40. The airflow leaving the fan 40 is divided into two separate airflows; one passing along the front air duct 50 to the slot-like opening 60 and the other passing along the rear air duct 52 to the slot-like opening 62.

As the airflow passes along the air ducts 50, 52, it divides into a plurality of airflow portions and flows past the vanes 100 located in each air duct 50, 52. The noise emitted by the motor is attenuated by the fact that the distance between the vanes 100 and the walls of the ducts 50, 52, and between the vanes 100 themselves, is restricted to a value which does not exceed the half-wavelength of the sound waves of the noise.

The airflow is ejected from the slot-like openings 60, 62 in the font of very thin, stratified sheets of high velocity, high pressure air. As the airflows leave the slot-like openings 60, 62, the air pressure is at least 15 kPa and preferably approximately 20 to 23 kPa. Furthermore, the speed of the airflow leaving the slot-like openings 60, 62 is at least 80 m/s and preferably at least 100 or 150 m/s, more preferably approximately 180 m/s. Because the size of the slot-like opening 62 located at the end of the rear duct 52 is greater than the size of the slot-like opening 60 located at the end of the front duct 50, a larger volume of air is emitted from the duct 52 than from the duct 50. This provides a greater mass of air for drying the backs of the user's hands which is advantageous.

The two thin sheets of stratified, high velocity, high pressure air are directed towards the surfaces of the user's hands which, during use, are inserted fully into the cavity 30 and are subsequently withdrawn from the cavity 30 via the cavity entrance 32. As the user's hands pass into and out of the cavity 30, the sheets of air blow any existing water off the user's hands. This is achieved reliably and effectively because of the high momentum of the air leaving the slot-like openings 60, 62 and because the airflow is evenly distributed along the length of each slot-like opening 60, 62.

Each stratified sheet of air is directed towards the wall of the cavity 30 which is remote from the slot-like opening through which the respective sheet of air is emitted. Because the slot-like openings 60, 62 are also inclined towards the lowermost end of the cavity 30, the emitted airflows are directed into the cavity 30. This reduces the risk of turbulent air movement being felt by the user outside the casing, e.g. in the user's face.

It is envisaged that it will take only a small number of “passes” of the hand dryer described above to dry a user's hands to a satisfactory degree. (By “pass”, we mean a single insertion of the hands into the cavity and subsequent removal therefrom at a speed which is not unacceptable to an average user. We envisage that a single pass will have a duration of no more than 3 seconds.) The momentum achieved by the airflows is sufficient to remove the majority of water found on the surface of the user's hands after washing during a single pass.

The water removed by the airflows is collected inside the cavity 30. Each airflow will rapidly lose its momentum once it has passed the user's hands and the water droplets will fall to the lower end of the cavity 30 under the forces of gravity whilst the air exits the cavity 30 either through the cavity entrance 32 or via the open sides of the cavity 30. The water, however, is collected by the drain 38 and passed to a reservoir (not shown) where it is collected for disposal. The reservoir can be emptied manually if desired. Alternatively, the hand dryer 10 can incorporate some form of water dispersal system including, for example, a heater for evaporating the collected water into the atmosphere. The means by which the collected water is dispersed does not form part of the present invention.

In an alternative embodiment, the slot-like openings 60a, 62a can be arranged so that the sheets of air which are emitted therefrom are directed generally along planes which are substantially parallel to one another. This minimises the amount of turbulent flow present inside the cavity 30 whilst the drying apparatus is in use.

The invention is not intended to be limited to the precise detail of the embodiment described above. Modifications and variations to the detail which do not alter the scope of the invention will be apparent to a skilled reader. For example, the shape of the cavity 30 and its entrance 32 may be altered without departing from the essence of the present invention. Also, the operational speed of the motor is not limited to the value given above but can be selected to provide the most suitable flowrate of air within the dryer.

1. A drying apparatus, comprising a casing, a cavity formed in the casing for receiving an object, a fan located in the casing and capable of creating an airflow, a motor provided in the casing for driving the fan and ducting for carrying the airflow from the fan to at least one opening arranged to emit the airflow into the cavity,
wherein the ducting comprises at least one air duct in which at least one vane is located, the vane extending in the direction of airflow and dividing the air duct into a plurality of airflow portions.

2. The drying apparatus as claimed in claim 1, wherein the each vane is positioned in the air duct such that the distance between the vane and any adjacent wall of the air duct or further vane is no more than a predetermined value.

3. The drying apparatus as claimed in claim 2, wherein the predetermined value is calculated as a function of the operating speed of the motor.

4. The drying apparatus as claimed in claim 2 or 3, wherein the predetermined value is calculated as a function of the speed of sound in the airflow passing along the air duct at the normal operating temperature.

5. The drying apparatus as claimed in claim 2 or 3, wherein the predetermined value is calculated according to the formula:
$$Predetermined Value = \frac{30 \times Speed of sound in air duct}{Operating speed of the motor \underline{.}}$$

6. The drying apparatus as claimed in claim 5, wherein the predetermined value is calculated according to the formula:
$$Predetermined Value = \frac{10800}{Operating speed of the motor \underline{.}}$$

7. The drying apparatus as claimed in claim 2 or 3, wherein the predetermined value is in the range from 100 mm to 150 mm.

8. The drying apparatus as claimed in claim 7, wherein the predetermined value is substantially 120 mm.

9. The drying apparatus as claimed in claim 2 or 3, wherein more than one vane is provided in the or each air duct.

10. The drying apparatus as claimed in claim 9, wherein the vanes are arranged in a plurality of rows.

11. The drying apparatus as claimed in claim 10, wherein adjacent rows of vanes overlap in the direction of the airflow.

12. The drying apparatus as claimed in claim 10, wherein the number of vanes in each row is higher than the number of vanes in a preceding row.

13. The drying apparatus as claimed in claim 2 or 3, wherein the breadth of the or each air duct increases between the fan and the opening.

14. The drying apparatus as claimed in claim 2 or 3, wherein the or each opening is a slot-like opening extending across the width of the cavity.

15. The drying apparatus as claimed in claim 14, wherein the width of the slot-like opening is no more than 0.8 mm.

16. The drying apparatus as claimed in claim 14, wherein the fan is adapted to cause an airflow to be emitted through the slot-like opening at a velocity of at least 100 m/s.

17. The drying apparatus as claimed in claim 16, wherein the fan is adapted to cause an airflow to be emitted through the slot-like opening at a pressure of at least 12 kPa.

18. The drying apparatus as claimed in claim 2 or 3, wherein the drying apparatus is a hand dryer.

19. (canceled)

20. The drying apparatus as claimed in claim 4, wherein the predetermined value in calculated according to the formula:
$$Predetermined Value = \frac{30 \times Speed of sound in air duct}{Operating speed of the motor \underline{.}}$$

21. The drying apparatus as claimed in claim 20, wherein the predetermined value is calculated according to the formula:
$$Predetermined Value = \frac{10800}{Operating speed of the motor \underline{.}}$$
